(19) United States
(12) Patent Application Publication
(10) Pub. No.: US 2017/0310639 A1
(43) Pub. Date: Oct. 26, 2017

(54) METHOD FOR CONFIGURING A TUNNEL CONNECTION FOR AN AUTOMATION NETWORK

(71) Applicant: SIEMENS AKTIENGESELLSCHAFT, Munchen (DE)

(72) Inventors: IGOR MILOVANOVIC, Nurnberg (DE); WOLFGANG RIEDL, Nurnberg (DE)

(73) Assignee: SIEMENS AKTIENGESELLSCHAFT, Munchen (DE)

(21) Appl. No.: 15/495,241

(22) Filed: Apr. 24, 2017

(30) Foreign Application Priority Data
Apr. 25, 2016 (EP) 16166831.4

(51) Int. Cl. H04L 29/06; H04L 29/12; H04L 29/08

(52) U.S. Cl. CPC H04L 63/029; H04L 67/12; H04L 61/1511; H04L 63/0236

(57) ABSTRACT

In a method for configuring a communication between a first computer with an automation engineering software and a second computer which is connected in a proprietary automation network, the first computer is run in a cloud environment. The communication between the first computer and the second computer is carried out by a tunnel protocol for establishing a tunnel connection, and a configuration of the tunnel connection is automatically configured by determining information heuristically.

### CROSS-REFERENCES TO RELATED APPLICATIONS

This application claims the priority of European Patent Application, Serial No. 16166831.4, filed Apr. 25, 2016, pursuant to 35 U.S.C. 119(a)-(d), the content of which is incorporated herein by reference in its entirety as if fully set forth herein.

### BACKGROUND OF THE INVENTION

The present invention relates to a method for configuration of a tunnel connection for an automation network.

The following discussion of related art is provided to assist the reader in understanding the advantages of the invention, and is not to be construed as an admission that this related art is prior art to this invention.

The engineering, the configuration and start-up of automation devices such as a programmable logic controller (PLC) or a user interface (human-machine interface, or HMI) are normally carried out with the aid of PC-based engineering software. The communication between the computer having installed engineering software and the automation device is usually carried out, for example in the Simatic S7, via a proprietary communication protocol.

In this case, the proprietary underlying communication network that connects the automation devices to one another (automation network) is normally separate from the other networks, in particular from external networks. This involves “standalone” networks, which are safeguarded with the aid of corresponding suitable network elements (firewalls).

The computer on which the PC-based engineering software runs has to be connected to the automation network, for example via Ethernet, bus or USB. This is not a problem in traditional scenarios when the engineer carries out the technical planning on the dedicated computer with the engineering software installed there. The situation is different in an environment in which data exchange is supported by means of cloud computing. The fact that the PC-based engineering software has to link to the automation device with the aid of the automation protocol makes the installation of the engineering software more complicated.

The term “cloud computing” is used throughout this disclosure to relate to the execution of programs which are not installed on the local computer, but rather on a different computer, which is called remotely (for example via the Internet). IT infrastructures (e.g. computing capacity, data memory, network capacities or else finished software) are made available via a network, without their having to be installed on the local computer. These services are offered and utilized exclusively via technical interfaces and protocols and via browsers. The range of the services offered in the context of cloud computing encompasses the entire spectrum of information technology and includes, inter alia, the infrastructure (e.g. computing power, memory space), platforms and software.

In order to avoid the problem that the automation software installed in the cloud environment cannot address the automation devices connected to the Internet and to the PC, the engineering software is extended with network tunneling software, for example.

In a network, the terms “tunnel” or “tunneling” denote the conversion and transmission of one communication protocol that is embedded into another communication protocol for transport. The original protocol is thus “spoken” upstream and downstream of the tunnel partners, while a different protocol is used between the tunnel partners, the different protocol serving for a different type of communication and nevertheless transporting the data of the original protocol. For this purpose, the tunnel software is required on both sides of the tunnel. Once it has embedded the original communication data into a different protocol, the software on the respective other side of the tunnel has to extract the data again and pass the latter on.

The automation protocol is tunneled via common Internet protocols (for example TCP or HTTP) in this way. The engineering PC acts as a network bridge and connects the automation software to the automation devices. Such an approach is illustrated in FIG. 1. A remote computer RC in the cloud is connected to the engineering PC, PC for example via the protocol https, the engineering PC in turn talking with the automation device, AD via a customary automation communication protocol, ACP.

The network tunneling software for automation protocols has to be configured before it can be used. For this purpose, according to the prior art the following steps are performed in order to establish a connection between the PC-based engineering software installed in the cloud and the automation device:
0. Activating the communication endpoint of the tunnel communication to the automation device (illustrated under the HTTPS endpoint PC in FIG. 2)
1. Setting up a connection via a shared (between remote PC, RC and engineering PC, PC) remote desktop solution (for example Microsoft RDP, VNC, Citrix) to the computer, PC, on which the PC-based engineering software is executed. The computer RC is generally used as a virtual machine in a cloud environment. In the example in FIG. 2, this computer has the address automationsoftware.example.dom.
2. Inputting the address of the communication endpoint on the computer for the PC-based software engineering, RC. In the example in FIG. 2, the address reads https://pgpc.example.dom.

It would be desirable and advantageous to provide an improved method to obviate prior art shortcomings and to considerably simplify a configuration complexity.

### SUMMARY OF THE INVENTION

According to one aspect of the present invention, a method for configuring a communication between a first computer with an automation engineering software and a second computer connected in a proprietary automation network, includes running the first computer in a cloud environment, carrying out the communication between the first computer and the second computer by using a tunnel protocol for establishing a tunnel connection, and automatically configuring a configuration of the tunnel connection by determining information heuristically.

The software for the tunnel communication can be extended with an auto-configuration function. The latter attempts to heuristically determine the address of the communication endpoint for the tunneling of the communication of the automation protocol. If the method is successful, the address does not have to be input manually.

Further advantageous features are set forth in the dependent claims, and may be combined with one another in any desired manner in order to achieve further advantages.

A method according to the present invention uses the fact that the PCs are already connected to one another via a type of computer remote desktop software (RDP), the PC-based engineering software, and that each PC operating system with network functions manages an internal list of network connections which can be read out.

### BRIEF DESCRIPTION OF THE DRAWINGS

Other features and advantages of the present invention will be more readily apparent upon reading the following description of currently preferred exemplified embodiments of the invention with reference to the accompanying drawings, in which:

FIGS. 1 and 2 are schematic illustrations of a conventional structure of network elements and configuration masks,

FIG. 3 shows a heuristic method for configuring the network software tunnel for automation protocols,

FIG. 4 shows a functional sequence diagram for the SCAN process, and

FIG. 5 shows a functional sequence diagram for the LEARN process.

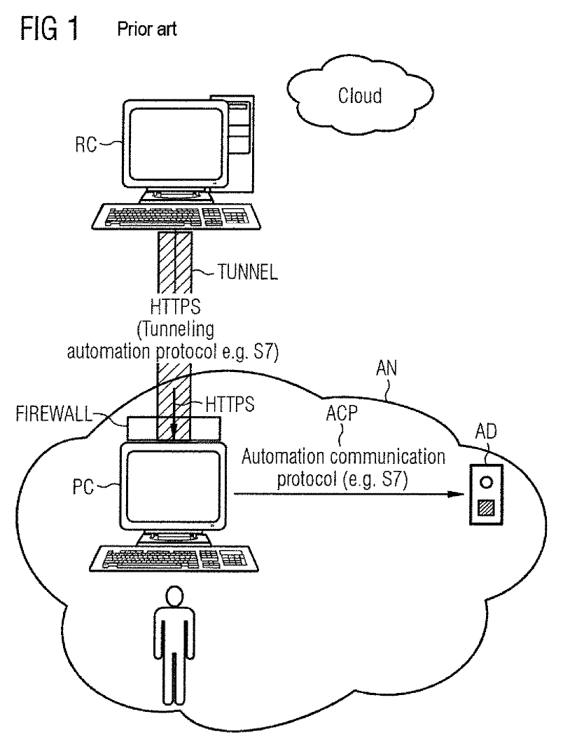

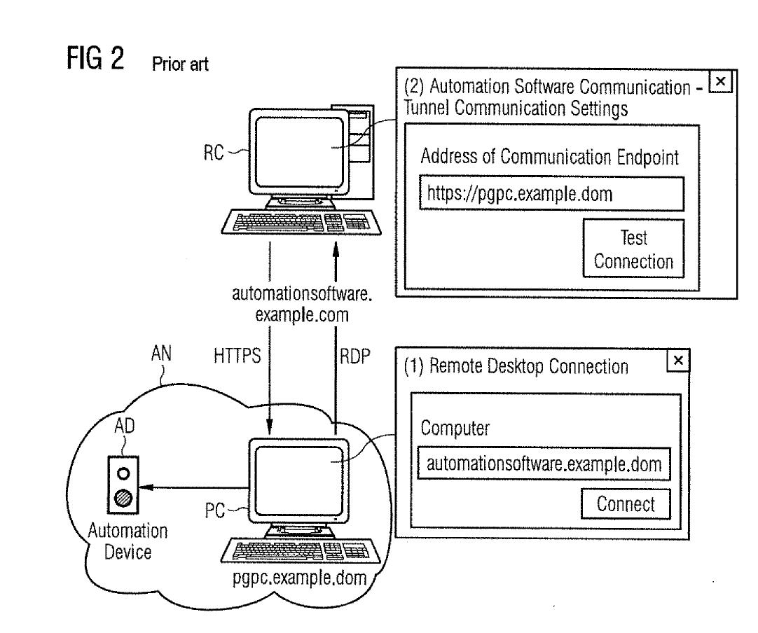

### DETAILED DESCRIPTION OF PREFERRED EMBODIMENTS

Throughout the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

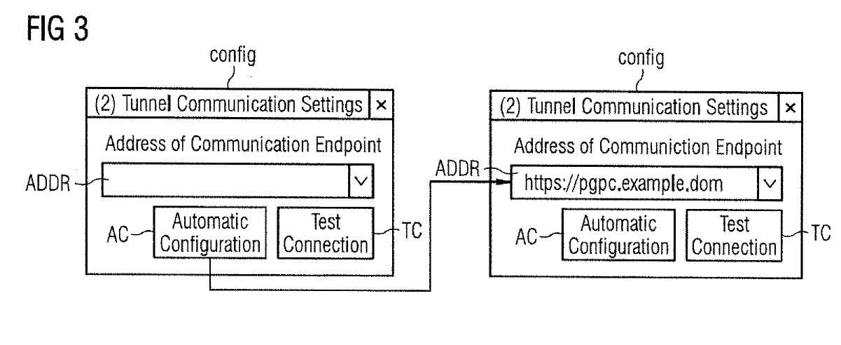

Referring now to FIG. 3, there is shown an advantageous embodiment of a method in accordance with the present invention. The method includes a scan process that is performed each time the user attempts to configure the network tunneling software automatically. Furthermore, it includes a learn process that is carried out each time the software creates a manually configured tunnel connection to the automation device.

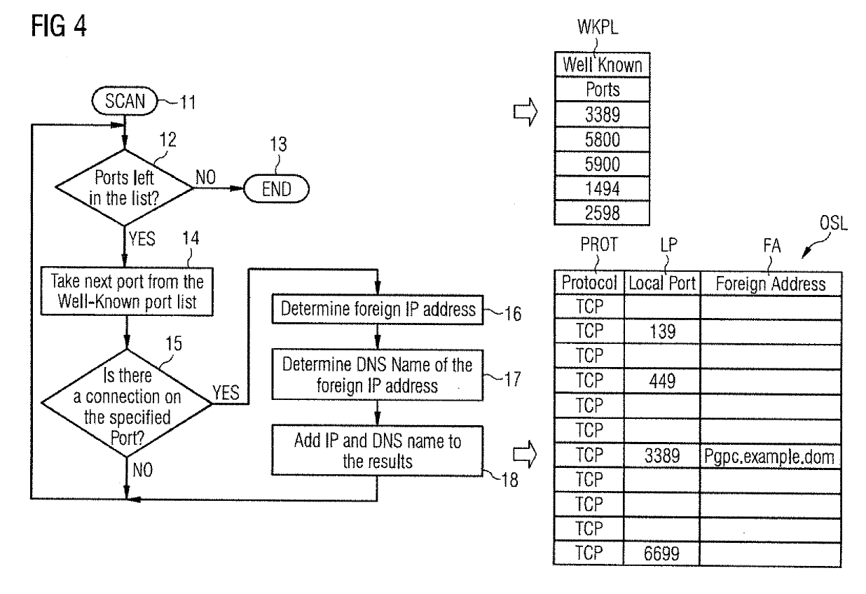

FIG. 4 then shows the SCAN process 11:

The software creates and maintains a list of the ports, which list is initially prefilled with known ports, WKPL—Well Known Port List WKPL. The latter are allocated by the shared remote desktop software; in the example, port number 3389 is used for Microsoft RDP, 5800, 5900 for VNC, 1494 and 2598 for Citrix.

The following steps are carried out for each port 12 in the list:

When a connection exists on the current port, step 15:
determine the IP address of the computer connected to the port (in the example port 3389), step 16
determine the DNS name for the IP address (in the example: Pgpc.example.dom), step 17
add both to the results in the list, step 18

When there are no results, the address may be configured manually, if appropriate, step 13.

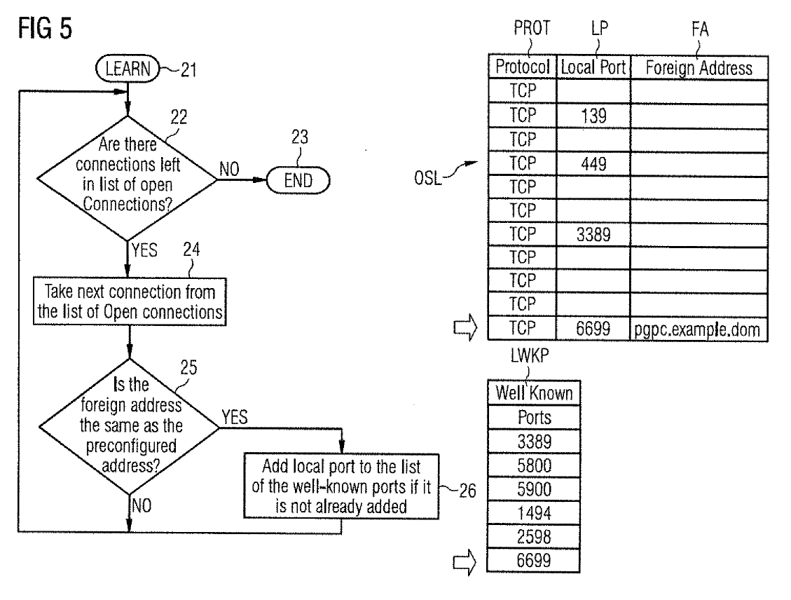

FIG. 5 describes the LEARN process 21:

When the user, as described above, has configured the remote address manually, then this probably means that the user is using remote desktop software that is not yet known—a non-standard (non-default) port or an unknown remote desktop protocol. The following method is then performed for the existing network connections of the computer on which the PC-based engineering software is executed:
Determine the foreign address of the connection, step 25:
when the foreign address is the same as the manually configured address, add the port to the list of the known ports WLPL, step 26.

In this way, the software can learn that the user will use different software for the connection to the engineering system the next time the SCAN process is performed.

The software utilizes apparently unrelated information (information about the well-known ports for remote desktop connections) to create an assumption about the correct configuration parameters for the software component that is responsible for the tunneling of the automation protocols. The software can also learn over the course of time from successful connections to identify previously unknown remote desktop software, etc.

In this case, a heuristic is generally an assessment which is determined by a calculation. This calculation is based on estimation, observation, assumptions or guessing. Heuristics serve for solving problems; e.g. during the search a heuristic is taken in order to find a “good” path or a “good” solution. The assessment is only as good as the “estimation”. Heuristics are used whenever an exact calculation of the optimum solution is impossible (e.g. too little information) or so complex that it is not worth the effort.

The configuration is carried out in a completely automated manner in most cases in accordance with the method according to the invention.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for configuring a communication between a first computer with an automation engineering software and a second computer connected in a proprietary automation network, said method comprising:
running the first computer in a cloud environment;
carrying out the communication between the first computer and the second computer by using a tunnel protocol for establishing a tunnel connection; and
automatically configuring a configuration of the tunnel connection by determining information heuristically.

2. The method of claim 1, wherein an https protocol is used as the tunnel protocol.

3. The method of claim 1, wherein the first computer has a first information of known communication connections.

4. The method of claim 3, wherein port numbers are contained in the first information, said method further comprising determining an external address with respect to a respective port number, said external address being an IP address and/or a DNS name.

5. The method of claim 3, wherein the first information contains no information of an existing communication connection, said method further comprising adding to the first information a second communication information associated with the existing communication connection.

6. The method of claim 5, wherein the second communication information is an IP address and/or a DNS name.
